(19) United States
(12) Patent Application Publication
(10) Pub. No.: US 2024/0192934 A1
(43) Pub. Date: Jun. 13, 2024

(54) FRAMEWORK FOR DEVELOPMENT AND DEPLOYMENT OF PORTABLE SOFTWARE OVER HETEROGENOUS COMPUTE SYSTEMS

(71) Applicant: Saankhya Labs Pvt Ltd, Bengaluru (IN)

(72) Inventors: Parag Naik, Bengaluru (IN); Anindya Saha, Bengaluru (IN); Vineet Gupta, Bengaluru (IN); Pramit Biswas, Bengaluru (IN); Makarand Kulkarni, Bengaluru (IN)

(21) Appl. No.: 18/064,251

(22) Filed: Dec. 10, 2022

(51) Int. Cl. G06F 8/41; G06F 8/73

(52) U.S. Cl. CPC G06F 8/427; G06F 8/73

(57) ABSTRACT

Configurations of a system and a method for implementing a framework that optimizes the execution and deployment of operations in a computationally intensive software applications including varying complexity workloads, are described. In one aspect, a portable framework (PF) may transform an algorithmic routine developed via an IDE into an intermediate form. The PF may enable adding constraint definitions to the intermediate form of the algorithmic software routine. The PF may further enable or provision including constraint definitions, hardware architecture description and multiple optimization metrics to the intermediate form. Based on the constraint definitions, the hardware architecture description, and the multiple optimization metrics the PF may determine computing resources from multiple heterogenous hardware resources deployed on a hardware platform. The execution of the operations may be optimized by deploying the operations to be executed on the determined computing resources.

### FIELD

The configurations of a heterogenous multi-processor system and a method for a framework that optimizes development, deployment and execution of operations or functions of computationally intensive software application with diverse workload characteristics, are described.

### BACKGROUND

Conventional or traditional implementations for an execution of certain types of workloads associated with functions or operations that are implemented in a multi-processor architecture may necessitate static binding with a proprietary hardware. Such static binding with the proprietary hardware may not only increase a complexity of software development process, but also adds to overall total cost of ownership. For instance, overheads resulting from such static binding arrangements may include, for example, underutilization of the proprietary hardware, an increase in infrastructure deployment cost, restriction in software development processes resulting in code that is platform bound, and proprietary hardware bound, etc. The aforementioned overheads are not only cumbersome but also inefficient in terms of utilization of the deployed infrastructure. Therefore, providing a mechanism that may improvise the software development process by enabling a developer to write code that is portable and is not statically bound to the proprietary hardware for implementing the execution of the functions or operations in the multi-processor architecture, may be challenging.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method that implements a framework to optimize development, deployment, and execution of operations of varied workloads in software applications, are described. In an embodiment, the system and method may include a portable framework (PF) that implements an execution of code, circuitries, tools, routines, components, etc., either independently or in cooperation, to execute operations or functions. The PF may execute operations to parse an annotated code associated with an algorithmic routine. The parsed code may be identified as a first representation, which may include, for example, multiple tasks, routines, workloads, etc., associated with the algorithmic routine. Further, the PF may execute operations to transform the first representation of the annotated code associated with the algorithmic routine into an intermediate form. Based on multiple constraint definitions, a hardware architecture description and multiple cost function optimization targets associated with the execution of the algorithmic routine, the intermediate form of the algorithmic routine may be analyzed. Based on the analysis, computing resources may be determined. The execution of the tasks on the determined computing resources may be optimized.

In an embodiment, the intermediate form of the algorithmic software routine eliminates the need of a static binding code for executing the tasks on the determined computing resources. A schedule generator may execute operations to schedule execution of the tasks associated with the algorithmic routine on the determined computing resources. A task dispatcher may create binary executables files corresponding to the tasks based on the schedule, and the binary executable files are executed on the determined computing resources.

In an embodiment, the algorithmic routine may be associated with operations or functions of computationally intensive software applications including varying workloads. The one or more computing resources on a hardware may include general purpose processors (GPPs), field programmable gate arrays (FPGAs), graphical processing units (GPUs), single core or multicore central processing units (CPUs), and network accelerator cards, etc. The hardware architecture description includes definitions of the configurations of the computing resources on the hardware platform and the network resources.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is an illustration of an environment that optimizes an execution of operations in a computationally intensive software applications including varying complexity workloads, according to an exemplary embodiment.

FIG. 2 is an illustration showing a system that optimizes an execution of operations in a computationally intensive software applications including varying complexity workloads, according to an exemplary embodiment.

FIG. 3 is an illustration of a process to optimize execution of operations in a computationally intensive software applications including varying complexity workloads, according to an exemplary embodiment.

FIG. 4 shows an exemplary hardware configuration of computer 400 that may be used to implement the PF) and the process, to optimize an execution of operations in the computationally intensive software applications including varying complexity workloads, according to exemplary embodiments.

### DETAILED DESCRIPTION

Implementations of techniques of a framework including heterogenous multi-processor for optimizing an execution of operations or functions of computationally intensive software applications including varying complexity workloads, are herein described.

In the foregoing description, the terms model or models, tools, components or software components, software applications or applications, software routines or routines, algorithmic routines or algorithmic routine, software code or code, tools or toolchains, software scripts or scripts, etc., may be used interchangeably throughout the subject specification, unless context warrants particular distinction(s) amongst the terms based on an implementation. The implementation may include an execution of a computer readable code, for example, a sequence or set of instructions, by a processor of a computing device (e.g., a special purpose computer, a general-purpose computer, a mobile device, computing devices configured to read and execute operations corresponding to the set of instructions, etc.) in an integrated framework or system. The computing device may be configured to execute the sequence or set of instructions to implement an execution of operations or functions by the processor of the computing device. The implementation of the execution of the operations or functions enables the computing device to adapt to function as the special purpose computer, thereby optimizing or improving the technical operational aspects of the special purpose computer. The execution of the operations or functions may be either independently or in cooperation, which may cooperatively enable a platform, or a framework, which optimizes the execution of operations or functions computationally intensive software applications including varying workloads. The aforementioned software components, software applications or applications, software routines or routines, algorithmic routines or algorithmic routine, software code or code, tools or toolchains, software scripts or scripts, etc., may be reconfigured to be reused based on definition and implementation.

In an embodiment, a workload may be a task, or a subtask associated with a software application of varying complexity. For instance, the workload may be simple or complex and may utilize the underlying computing resources to implement its execution. The workloads may be of different types and may be classified as static workloads or dynamic workloads. For example, static workloads may be tasks associated with an operating system (OS), enterprise resource management software application, etc. The dynamic workloads may include multiple instances of software applications, such as a test software application. In an embodiment, high-performance computing (HPC) or computationally intensive workloads may be related to analytical workloads, perform significant computational work and, typically, demand a large amount of processor (CPU) and storage (e.g., main system memory as well as processor caches) resources to accomplish demanding computational tasks with execution timing constraints, even in real time. For example, such computationally intensive workloads may be associated with artificial intelligence (AI)/machine learning (ML) based computations, operations, or functions in a mobile network, such as 5G, etc. In an embodiment, the execution timing constraints in real time may correspond to a short bounded response time within which certain tasks may be executed.

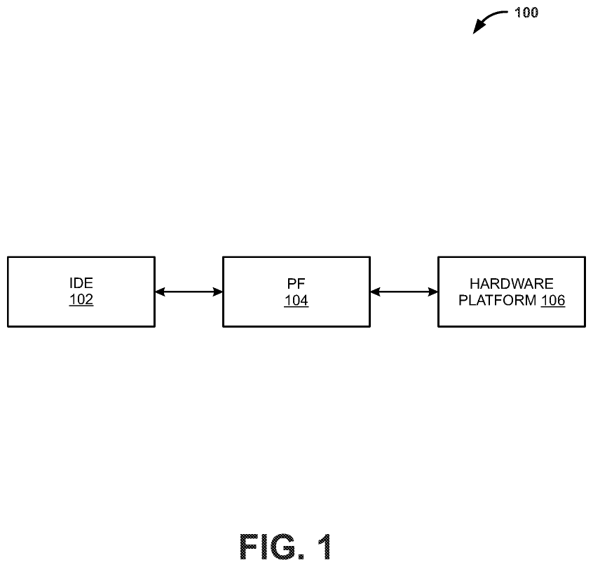

FIG. 1 is an illustration of an environment 100 that optimizes an execution of operations computationally intensive software applications including varying workloads, according to an exemplary embodiment. FIG. 1 is an illustration showing an environment 100 that optimizes an execution of operations in the computationally intensive software applications including varying workloads. In an embodiment, the environment 100 includes a communicatively coupled arrangement of an integrated development environment (IDE) 102, a portable framework (PF) 104, and a hardware platform 106. The PF 104 may implement a mechanism that may include an execution of algorithmic routines, tools, components, etc., either independently or in cooperation with other components, to optimize an execution of operations for a domain specific software applications, consisting of varying complexity workloads, on a heterogenous multi-processor framework.

In an embodiment, the IDE 102 may enable a software developer to write a code or develop algorithmic routine(s) related to the operations or the functions of the computationally intensive software applications including varying complexity workloads. The algorithmic routines may be developed using a high level language, such as C, C++, etc. The PF 104 may implement components, routines, tools, etc., to transform the code high level language of the algorithmic routine into an intermediate form. The PF 104 may further execute operations such as, analyzing the intermediate form of the code, including, or embedding attributes, such as constraint definitions, hardware architecture description, optimization metrics, and executing operations to make determination of computing resources for implementing the execution of the algorithmic routine. For instance, there may be certain attributes associated with each computing resource that may in turn influence the cost factor associated with the execution of algorithmic routine on it. For example, the attributes associated with the computing resources may include an execution time, an amount of CPU cycles consumed for the execution, a power consumed for the execution etc. Based on the aforementioned attributes or other optimization targets or cost functions impacted by chosen precision (e.g., Cascaded Noise Figure), the constraint definitions, the hardware architecture description, the optimization metrics, the computing resources for optimally executing the tasks may be determined. The intermediate form of the algorithmic routine may be scheduled to be executed on the determined computing resources.

In an embodiment, the hardware platform 106 may include multiple heterogenous hardware resources that may also be referred to as computing resources, which may implement the operations or functions in the varying complexity workloads consisting of domain specific computationally intensive software applications. The terms heterogenous hardware resources, a hardware platform, a target hardware platform, etc., may be used interchangeably in the subject specification and may correspond to the hardware platform (e.g., 106 and 206) as shown and described. In an embodiment, the hardware platform 106 may include multiple computing resources such as, general purpose processors (GPPs), field programmable gate arrays (FPGAs), graphical processing units (GPUs), single core or multicore central processing units (CPUs), network accelerator cards, etc. In an embodiment, a hardware architecture description of the multiple computing resources on the hardware platform 106 may be created and updated dynamically on demand by the PF 104. A dynamic instantiation by the PF 104 may enable dynamically using the computing resources on the hardware platform 106. For example, when the computing resources are added, or removed or fail to operate, the PF 104 may execute operations to modify or update the hardware architecture description and reconfigure the computing resources, thereby enabling an uninterrupted execution of the operations in the domain specific computationally intensive software applications constituting varying complexity workloads.

In operation, the IDE 102 may enable developing algorithmic routines or code related to the functions or operations of the computationally intensive software applications including varying complexity workloads. Further, the PF 104 may execute operations to transform the algorithmic routines into an intermediate abstract format. The PF 104 may enable adding or embedding constraint definitions to the intermediate abstract format of the algorithmic routines. The PF 104 may enable or provision embedding or including constraint definitions, hardware architecture description and multiple algorithm optimization metrics to the intermediate abstract format of the algorithmic routines. Further, the PF 104 may execute operations to determine computing resources and upon such determination the PF 104 may execute operations to create binary executable files corresponding to the algorithmic routines and schedule the execution of these binary executables on the determined computing resources. In an embodiment, the mechanism of optimizing the execution of operations in the computationally intensive software applications including varying complexity workloads by the PF 104 may include determining one or more computing resources from an arrangement including multiple heterogenous compute elements deployed on the hardware platform 106 and deploying the execution of operations on the determined one or more computing resources.

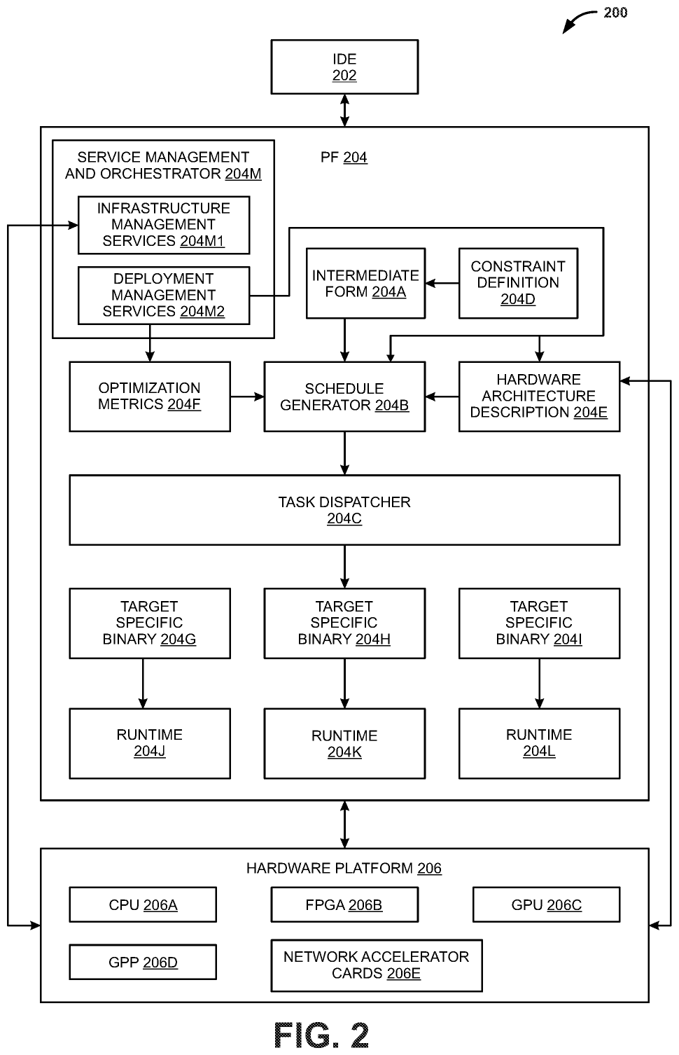

FIG. 2 is an illustration showing a system 200 that optimizes an execution of operations computationally intensive software applications including varying complexity workloads, according to an exemplary embodiment. FIG. 2 is described in conjunction with FIG. 1. FIG. 2 is an illustration showing a system 200 that implements a mechanism (e.g., a framework) to optimize an execution of the operations in the computationally intensive software applications including varying complexity workloads. The system 200 includes a communicative couple arrangement of an IDE 202, a portable framework (PF) 204, and a hardware platform 206.

In an embodiment, the IDE 202 may enable a software developer to write a code or develop the algorithmic routines corresponding to the operations in the computationally intensive software applications including varying complexity workloads. The IDE 202 may enable developing the algorithmic routines or using any high level programming language, such as C, C++, etc. In an embodiment, the algorithmic routines may include declarative statements or declarative definitions, annotations, special markers, abstract primitives, programming language specific intrinsic functions or intrinsics, etc. The declarative statements or declarative definitions may correspond to optimizations that may be enforced or implemented for optimally executing the operations or functions of algorithmic routines. The algorithmic routines written or developed using the high level language may also be represented or referred to as a first representation including the annotations. In an embodiment, the algorithmic routines may correspond to operations or functions of the high-performance computing (HPC) software, such as artificial intelligence (AI) 5G edge analytics, AI acceleration, operations or functions executing in the, for example, the PHY layer, the RLC, the MAC layer, and PDCP, etc.

In an embodiment, the special markers, abstract primitives, intrinsics, etc., may enable, for example, a frontend parser to generate directed flow graphs (DFGs) from the algorithmic routines definition containing the aforementioned special markers, abstract primitives, intrinsics etc., and may also enable determining one or more tasks or one or more workloads for the underlying heterogenous computing platform. In an embodiment, the term intrinsics may also be referred to or known as intrinsic functions, built-in functions, built-ins, native functions, magic functions, etc., and may correspond to functions that may be compiled by a compiler for a specific component of the heterogenous computing platform. The compiler may further determine operational efficacies of the functions and substitute the determined function with a code that is optimized for execution of operations using the determined computing resources. The one or more tasks may be implemented to be executed in parallel and may also include information related to inter process communication (IPC) to enable data flow between the processes.

In an embodiment, the special markers, the abstract primitives, the intrinsics, etc., may further indicate constructs of the algorithmic routine, such as nodes, edges of graphs, etc., that may enable identifying, for example, tasks, operations, workloads, or functions related to the signal processing chain in the computationally intensive software applications including varying complexity workloads. The frontend parser may use the information related to the constructs, the components of the tasks, operations, workloads, functions, etc., related to the signal processing chain in the computationally intensive software applications including varying complexity workloads, to generate the DFGs. The DFGs may enable analysing the code, when the first representation of the code is transformed or converted into the intermediate abstract format. In an embodiment, the abstract primitives in the algorithmic routines may be related to, for example, tasks, routines, operations, workloads, inter process communication (IPC) mechanisms (e.g., queues, locks, etc.). The abstract primitives may define the constructs of the signal processing flow as the DFG. For example, the abstract primitives may include a Task START and STOP indicator; a NEXT node indicator; a WAIT for signal or a node to complete, etc. The tasks marked in UPPER case form may correspond to the pseudo-mnemonics for the operations performed.

In an embodiment, the PF 204 may execute operations to transform the algorithmic routines, for example, the first representation of the code into an intermediate abstract format. The intermediate abstract format may also be referred to as intermediate form 204A. Transforming the first representation of the code into the intermediate form 204A may include translating or substituting the declarative statements or declarative definitions into imperative statements. The imperative statements may include code or information that may implement an execution of the one or more tasks or the one or more workloads of the algorithmic routines on the determined computing resources. The declarative statements may further include information related to, for example, algorithmic optimizations. In an embodiment, the PF 204 may implement an execution of a toolchain, for example a frontend parser such as, clang in LLVM, to transform the first representation of the algorithmic routines into the intermediate form. The intermediate form of the algorithmic routine may include information related to Directed Flow Graphs (DFG) or Abstract Syntax Tree (AST).

In an embodiment, the intermediate form 204A of the code (e.g., algorithmic routines) may not include any binding code or binding information to bind the execution of the one or more tasks or the one or more workloads to specific hardware or computing resources. The intermediate form 204A of the code (e.g., algorithmic routines) may therefore eliminate the need of including or embedding code for statically binding the execution of the one or more tasks or the one or more workloads on specific hardware or the computing resources. The intermediate form 204A of the algorithmic routines may enable determining scheduling operations for executing the one or more tasks or one or more workloads on a determined computing resources deployed on the hardware platform 206. For example, to determine the computing resources that may be optimal for executing the one or more tasks or the one or more workloads of the algorithmic routines, the PF 204 may execute operations to make determinations based on multiple attributes, such as optimizing metrics 204F.

In an embodiment, the PF 204 may further enable including multiple constraint definition 204D to the intermediate form 204A of the algorithmic routines. The constraint definition(s) 204D may also be referred to as constraints, which may include information related to, for example, definitions on limits on the execution time or limits on the resource utilization of the one or more tasks or the one or more workloads or restrictions on which hardware or part thereof the task or more than one task or workload(s) can execute. For example, the constraint definition 204D may include information of time limit for executing the one or more tasks, limit on a power consumed for executing the one or more tasks, information related to cascaded noise figure, etc. In an embodiment, the constraint definition 204D may further be used as a metric by, for example, a schedule generator 204B. The schedule generator 204B may use the metric as an optimization metric (e.g., 204F) that may be related to an overall system performance. Based the optimization metrics 204F, the schedule generator 204B may further execute operations by applying or enforcing the constraint definition 204D to optimize the execution of the operations in the computationally intensive software applications including varying complexity workloads and an overall system performance. In an embodiment, the constraint definition 204D may further include information related to the inter-processor communication (IPC) mechanisms, which may define or limit flow of data between the computing resources.

In an embodiment, upon adding the constraint definition 204D, the PF 204 may execute operations to schedule the execution of the one or more tasks or the one or more workloads of the algorithmic routines. The schedule generator 204B may be configured to execute operations for analysing the intermediate form 204A of the algorithmic routines. The schedule generator 204B may execute operations for determining the computing resources that may be optimal for scheduling the execution of the one or more tasks or the one or more workloads of the algorithmic routines. In an embodiment, the computing resources that may be optimal for scheduling the execution of the one or more tasks or the one or more workloads may be determined based on constraint definition 204D, the optimization metrics 204F, and the hardware architecture description 204E. For instance, the hardware architecture description 204E may include definitions of the underlying hardware platform 206, such as the computing resources (e.g., 206A, 206B, 206C, 206D, and 206E), memory layouts, network resources, etc. In an embodiment, the network resources enable managing the flow of data or traffic into and out of the network. For instance, egress is a mechanism that includes data being shared externally via a network's outbound traffic. When thinking about ingress vs. egress, data ingress refers to traffic that comes from outside the network and is transferred into it. Egress traffic is a commonly used term that describes the amount of traffic that gets transferred from a host network to external networks and enables blocking the transfer of sensitive data outside networks, while limiting and blocking high-volume data transfers. Further, the schedule generator 204B may execute operations to embed or include information for implementing execution of inter process communications (IPC) between the computing resources. Such mechanism may be used to implement execution of the operations and manage the flow of data between the computing resources. For example, consider the algorithmic routine is associated with channel encoding in a wireless communication system. When the tasks associated with the channel encoding are implemented in a 20 MHz channel bandwidth, the PF 204 may determine that the computing resource, for example, the CPU may be optimal for executing the corresponding tasks. When the tasks associated with channel encoding are implemented in a 100 MHz channel bandwidth, the PF 204 may determine that the computing resource, for example, the FPGA may be optimal for executing the corresponding tasks. The above example includes an implementation of an execution of the operations or functions of the varying complexity workloads including computationally intensive software applications associated with the domain of a communication system.

In an embodiment, based on the optimization metrics 204F, the constraint definition 204D, and the hardware architecture description 204E, the schedule generator 204B may generate and implement graph partitioning algorithms to schedule the execution of the one or more tasks or the one or more workloads on the determined computing resources. The constraint definition 204D may be generated based on simulations of the execution of the operations or the functions or by analysis of the assembly instructions generated at the time of binding the binary executables to the specific platform or component thereof selected in the portable framework 204 and may be reused across platforms. In an embodiment, the intermediate form 204A of the code including the constraint definition 204D, the optimization metrics 204F, and the hardware architecture description 204F may enable the code to be portable that may be optimized and be executed on any computing resources from the hardware platform 206.

In an embodiment, the PF 204 may implement an execution of, for example, a task dispatcher 204C, to create executable binary files corresponding to each task or workload from the one or more tasks or the one or more workloads of the algorithmic routines. The created binary files may include code or information of the one or more tasks or the one or more workloads, the IPC, the DFGs, the determined computing resources for executing the one or more tasks or the one or more workloads, etc., that are in an executable format. Such files may also be referred to as executable binaries (e.g., target specific binary files or target specific binaries), that may be scheduled to be executed on the determined computing resources (e.g., 206A or 206B or 206C or 206D or 206E). At a run time (e.g., 204J, 204K, 204L), each executable binary (e.g., 204G, 204H and 204I) may be loaded and executed through the runtime on the determined one or more computing resources (e.g., 206A or 206B or 206C or 206D or 206E) on the underlying targeted hardware platform. Based on the DFGs, IPCs, etc., the task dispatcher 204C may also execute operations for performing late bindings to platform specific APIs.

In an embodiment, a service management and orchestrator 204M may be communicatively coupled with the schedule generator 204B and the hardware platform 206. The service management and orchestrator 204M may further include modules, such as an infrastructure management services 204M1 and deployment management services 204M2. The deployment management services 204M2 module may be used to manage the operations of the task dispatcher 204C. The deployment management services 204M2 module may instantiate the schedule generator. The optimization metrics and hardware architecture description including the user inputs are all assimilated by the infrastructure management services 204M1. The service management and orchestrator 204M may further include definitions and information including key requirements and high-level architecture principles for service management and orchestration. The key requirements may include information or data related to environment for enabling fast service to execute operations like componentization, parameterization and personalization, interaction with network management and orchestration for optimized utilization of network infrastructure for different service needs, using real time analytics to enable decision making, and optimization based on massive information collection from the network and service infrastructure.

In an embodiment, the runtime (e.g., 204J, 204K and 204L) may provide the final bindings, for example, DSP kernels ported on the platform or drivers needed to implement the IPC mechanisms for the data transfer. In an embodiment, the runtimes (e.g., 206J or 206K or 206L) may be generated by the PF 204 or provided by the hardware vendors supplying the computing resources (e.g., 206A or 206B or 206C or 206D or 206E) for the hardware platform 206. In an embodiment, based on the constraint definition 204D, the optimization metrics 204F and the hardware architecture description 204E, the PF 204 may determine one or more computing resources (e.g., 206A or 206B or 206C) and implement the execution of the algorithmic routines, which may optimize the execution of the operations of in the computationally intensive software applications including varying complexity workloads.

In an embodiment, the hardware platform 206 may include multiple heterogenous hardware resources that may also be referred to as computing resources (e.g., 206A or 206B or 206C or 206D or 206E), that may implement the execution of the operations or the functions in the computationally intensive software applications including varying complexity workloads. The multiple computing resources on the hardware platform 206 may include, for example, single core or multicore central processing units (CPUs) (e.g., 206A), field programmable gate arrays (FPGAs) (e.g., 206B), graphical processing units (GPUs) (e.g., 206C), general purpose processors (GPPs) (e.g., 206D), network accelerator cards (e.g., 206E), etc.

In an embodiment, the above-described mechanism for development of algorithmic routines using the PF (e.g., 104 and 204) may enable developing code that is heterogenous and portable, whose execution may be deployed or implemented using any computing resources (e.g., 206A or 206B or 206C or 206D or 206E). The PF (e.g., 104 and 204) may facilitate deploying an infrastructure that enables coexistence of heterogeneous computing resources and software code that may be developed without any platform or hardware resource binding information. Further, the PF (e.g., 104 and 204) may enable disaggregating the deployment of the computing resources (e.g., 206A or 206B or 206C or 206D or 206E) for implementing the execution of operations or functions (e.g., corresponding to the algorithmic routines) in the computationally intensive software applications including varying complexity workloads. In an embodiment, the implementation of the execution of the operations or functions enables the computing device to adapt to function as a special purpose computer, thereby optimizing or improving the technical operational aspects of the special purpose computer.

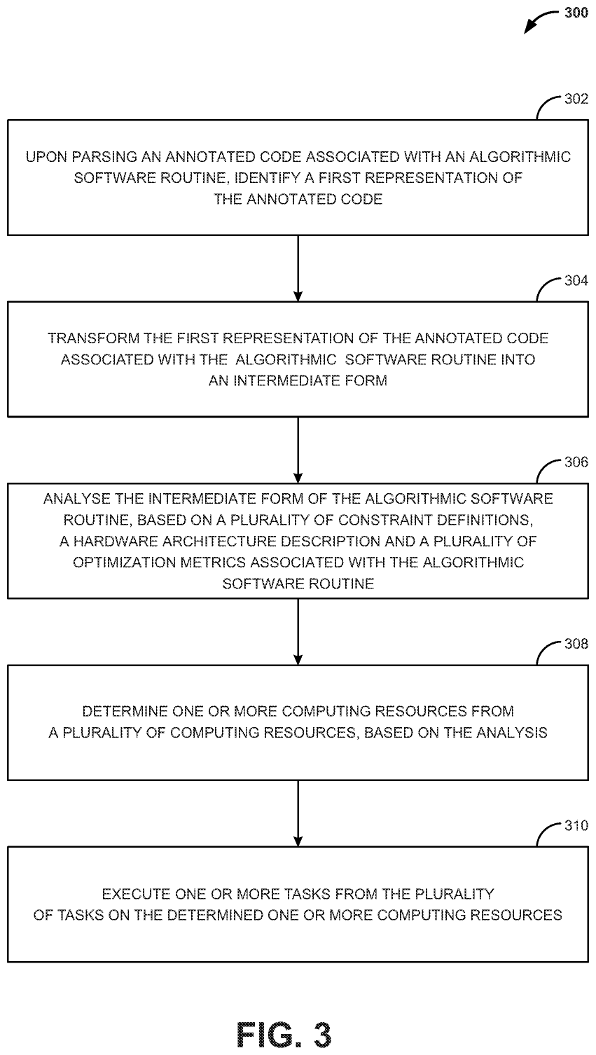

FIG. 3 is an illustration of a process 300 to optimize an execution of operations in the computationally intensive software applications including varying complexity workloads, according to an exemplary embodiment. FIG. 3 is described in conjunction with FIG. 1 and FIG. 2. The process steps, for example, 302, 304, 306, 308 and 310, of the process 300 are implemented by components, tools, routines, etc., of the PF (e.g., 104 and 204), as described with reference to FIG. 1 and FIG. 2. At step 302, an annotated code associated with an algorithmic routine is parsed and a first representation of the annotated code, is identified. At step 304, the first representation of the annotated code associated with the algorithmic routine is transformed into an intermediate form. At step 306, the intermediate form of the algorithmic routine is analyzed, based on a plurality of constraint definitions, a hardware architecture description and a plurality of optimization metrics associated with the algorithmic routine. At step 308, based on the analysis of the existing hardware state, constraints, and optimization targets, one or more computing resources from a plurality of computing resources, are determined. At step 310, one or more tasks from the plurality of tasks on the determined one or more computing resources, is executed. The operational efficacies of the process 300 steps, for example, 302, 304, 306, 308 and 310 are as described with reference to FIG. 1 and FIG. 2.

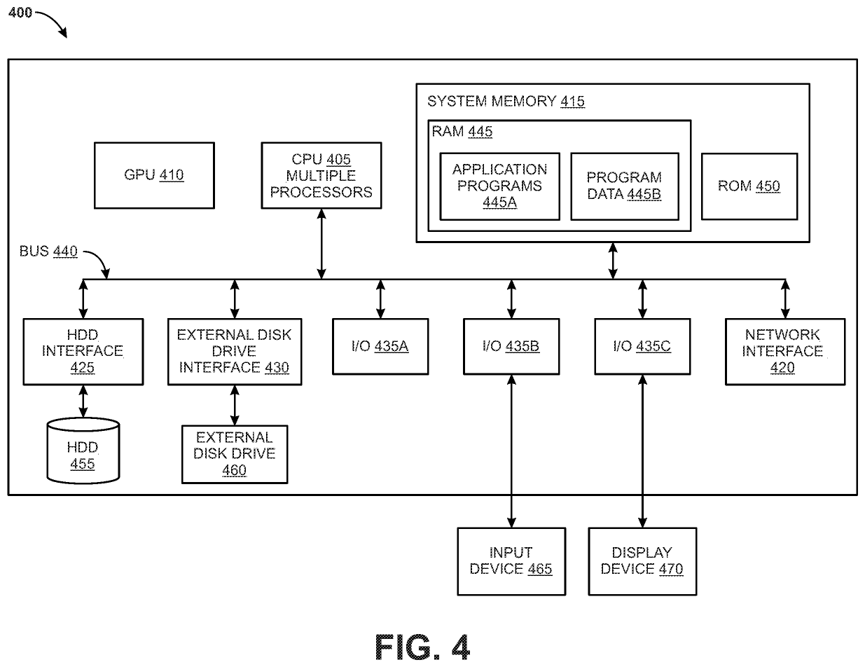

FIG. 4 shows an exemplary hardware configuration of computer 400 that may be used to implement the PF (e.g., 104 and 204) and the process (e.g., 300) to optimize an execution of operations in the computationally intensive software applications including varying complexity workloads, according to exemplary embodiments. The computer 400 shown in FIG. 4 includes CPU 405, GPU 410, system memory 415, network interface 420, hard disk drive (HDD) interface 425, external disk drive interface 430 and input/output (I/O) interfaces 435A, 435B, 435C. These elements of the computer are coupled to each other via system bus 440. The CPU 405 may perform arithmetic, logic and/or control operations by accessing system memory 415. The CPU 405 may implement the processors of the exemplary devices and/or system described above. The GPU 410 may perform operations for processing graphic or AI tasks. In case computer 400 is used for implementing exemplary central processing device, GPU 410 may be GPU 410 of the exemplary central processing device as described above. The computer 400 does not necessarily include GPU 410, for example, in case computer 400 is used for implementing a device other than central processing device. The system memory 415 may store information and/or instructions for use in combination with the CPU 405. The system memory 415 may include volatile and non-volatile memory, such as random-access memory (RAM) 445 and read only memory (ROM) 450. A basic input/output system (BIOS) containing the basic routines that helps to transfer information between elements within the computer 400, such as during start-up, may be stored in ROM 450. The system bus 440 may be any of several types of bus structures including a memory bus or memory controller, a peripheral bus, and a local bus using any of a variety of bus architectures.

The computer may include network interface 420 for communicating with other computers and/or devices via a network.

Further, the computer may include hard disk drive (HDD) 455 for reading from and writing to a hard disk (not shown), and external disk drive 460 for reading from or writing to a removable disk (not shown). The removable disk may be a magnetic disk for a magnetic disk drive or an optical disk such as a CD ROM for an optical disk drive. The HDD 455 and external disk drive 460 are connected to the system bus 440 by HDD interface 425 and external disk drive interface 430, respectively. The drives and their associated non-transitory computer-readable media provide non-volatile storage of computer-readable instructions, data structures, program modules and other data for the general-purpose computer. The relevant data may be organized in a database, for example a relational or object database.

Although the exemplary environment described herein employs a hard disk (not shown) and an external disk (not shown), it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

Several program modules may be stored on the hard disk, external disk, ROM 450, or RAM 445, including an operating system (not shown), one or more application programs 445A, other program modules (not shown), and program data 445B. The application programs may include at least a part of the functionality as described above.

The computer 400 may be connected to input device 465 such as mouse and/or keyboard and display device 470 such as liquid crystal display, via corresponding I/O interfaces 435A to 435C and the system bus 440. In addition to an implementation using a computer 400 as shown in FIG. 4, a part or all the functionality of the exemplary embodiments described herein may be implemented as one or more hardware circuits. Examples of such hardware circuits may include but are not limited to: Large Scale Integration (LSI), Reduced Instruction Set Circuits (RISC), Application Specific Integrated Circuit (ASIC) and Field Programmable Gate Array (FPGA).

One or more embodiments are now described with reference to the drawings, wherein like reference numerals are used to refer to like elements throughout. In the following description, for purposes of explanation, numerous specific details are set forth to provide a thorough understanding of the various embodiments. It is evident, however, that the various embodiments can be practiced without these specific details (and without applying to any networked environment or standard).

As used in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made considering the above detailed description. Rather, the scope is to be determined by the following claims, which are to be interpreted in accordance with established doctrines of claim construction.

What is claimed is:

1. A system, comprising:
a processor;
a memory storing instructions which when executed by the processor, perform operations to:
upon parsing an annotated code associated with an algorithmic routine, identify a first representation of the annotated code, wherein the first representation of the annotated code includes a plurality of tasks corresponding to the algorithmic routine;
transform the first representation of the annotated code associated with the software algorithmic routine into an intermediate form, wherein the intermediate form includes the plurality of tasks associated with the algorithmic routine;
based on a plurality of constraint definitions, a hardware architecture description and a plurality of optimization metrics associated with the algorithmic routine, analyse the intermediate form of the algorithmic routine;
based on the analysis:
determine one or more computing resources from a plurality of computing resources; and
execute one or more tasks from the plurality of tasks on the determined one or more computing resources, wherein the plurality of tasks are associated with the algorithmic routine.

2. The system of claim 1, wherein the intermediate form of the algorithmic routine eliminates a need of a static binding code for executing the one or more tasks on the determined one or more computing resources.

3. The system of claim 1, further comprises: schedule an execution of the one or more tasks from the plurality of tasks associated with the algorithmic routine on the determined one or more computing resources.

4. The system of claim 1, further comprises: create one or more binary executables files corresponding to the one or more tasks based on the schedule, wherein the one or more binary executable files are executed on the determined one or more computing resources at a runtime.

5. The system of claim 1, wherein the algorithmic routine is associated with one or more operations executed in a plurality of varying complexity workloads including domain specific computationally intensive software applications.

6. The system of claim 1, further comprises: determine the one or more computing resources on a hardware platform selected from a group consisting of general-purpose processors (GPPs), field programmable gate arrays (FPGAs), graphical processing units (GPUs), single core or multicore central processing units (CPUs), and network accelerator cards, and a combination thereof.

7. The system of claim 1, wherein the hardware architecture description comprises a plurality of definitions including the plurality of computing resources on the hardware platform and a plurality of network resources.

8. The system of claim 1, wherein the first representation of the annotated code comprises a plurality of annotations, a plurality of special markers, a plurality of abstract primitives, and a plurality of programming language specific intrinsic functions.

9. The system of claim 1, further comprises: generate a plurality of directed flow graphs corresponding to the plurality of tasks associated with the algorithmic routine.

10. The system of claim 1, wherein transforming the first representation of the annotated code associated with the software algorithmic routine into an intermediate form includes substituting the plurality of declarative statements with the plurality of imperative statements.

11. A method, comprising:
upon parsing an annotated code associated with an algorithmic routine, identifying a first representation of the annotated code, wherein the first representation of the annotated code includes a plurality of tasks corresponding to the algorithmic routine;
transforming the first representation of the annotated code associated with the software algorithmic routine into an intermediate form, wherein the intermediate form includes the plurality of tasks associated with the algorithmic routine;
based on a plurality of constraint definitions, a hardware architecture description and a plurality of optimization metrics associated with the algorithmic routine, analysing the intermediate form of the algorithmic routine;
based on the analysis:
determining one or more computing resources from a plurality of computing resources; and
executing one or more tasks from the plurality of tasks on the determined one or more computing resources, wherein the plurality of tasks are associated with the algorithmic routine.

12. The method of claim 11, wherein the intermediate form of the algorithmic routine eliminates a need of a static binding code for executing the one or more tasks on the determined one or more computing resources.

13. The method of claim 11, further comprising: scheduling an execution of the one or more tasks from the plurality of tasks associated with the algorithmic routine on the determined one or more computing resources.

14. The method of claim 11, further comprising: creating one or more binary executables files corresponding to the one or more tasks based on the schedule, wherein the one or more binary executable files are executed on the determined one or more computing resources at a runtime.

15. The method of claim 11, wherein the algorithmic routine is associated with one or more operations executed in a plurality of varying complexity workloads including domain specific computationally intensive software applications.

16. The method of claim 11, further comprising: determining the one or more computing resources on a hardware platform selected from a group consisting of general-purpose processors (GPPs), field programmable gate arrays (FPGAs), graphical processing units (GPUs), single core or multicore central processing units (CPUs), and network accelerator cards, and a combination thereof.

17. The method of claim 11, wherein the hardware architecture description comprises a plurality of definitions including the plurality of computing resources on the hardware platform and a plurality of network resources.

18. The method of claim 11, wherein the first representation of the annotated code comprises a plurality of annotations, a plurality of special markers, a plurality of abstract primitives, and a plurality of programming language specific intrinsic functions.

19. The method of claim 11, further comprises: generating a plurality of directed flow graphs corresponding to the plurality of tasks associated with the algorithmic routine.

20. The method of claim 11, wherein transforming the first representation of the annotated code associated with the software algorithmic routine into an intermediate form includes substituting the plurality of declarative statements with the plurality of imperative statements.
